(19) United States
(12) Patent Application Publication
(10) Pub. No.: US 2017/0103464 A1
(43) Pub. Date: Apr. 13, 2017

(54) DATA AGGREGATION FOR PROCESSING AND ANALYZING 529 PLAN DATA

(71) Applicant: The Bank of New York Mellon, New York, NY (US)

(72) Inventors: Alexandra S. Sanders, Charlton, MA (US); David M. Gauntt, Portsmouth, RI (US); Sara Geraghty, Marlborough, MA (US); Bryan E. Anderson, Milford, MA (US); Timothy B. Calderara, Cranston, RI (US); Erica Kuharich, Holliston, MA (US); Mohan N. Pandhare, N. Chelmsford, MA (US); Luther Townsend, Merrimack, NH (US)

(21) Appl. No.: 15/296,693

(22) Filed: Oct. 18, 2016

Related U.S. Application Data
(63) Continuation of application No. 14/657,809, filed on Mar. 13, 2015.
Application No. 14/657,809 is a continuation-in-part of application No. 14/076,394, filed on Nov. 11, 2013.
Application No. 14/076,394 is a continuation of application No. 13/348,116, filed on Jan. 11, 2012, now Pat. No. 8,583,532.
Application No. 13/348,116 is a continuation of application No. 13/012,488, filed on Jan. 24, 2011, now abandoned.
Application No. 13/012,488 is a continuation of application No. 12/797,358, filed on Jun. 9, 2010, now Pat. No. 7,877,310.
Application No. 12/797,358 is a continuation of application No. 11/710,685, filed on Feb. 26, 2007, now Pat. No. 7,756,771.
Application No. 11/710,685 is a continuation of application No. 11/477,170, filed on Jun. 28, 2006, now abandoned.
Application No. 11/477,170 is a continuation of application No. 11/255,476, filed on Oct. 21, 2005, now abandoned.
(60) Provisional application No. 60/621,021, filed on Oct. 21, 2004.

(51) Int. Cl. G06Q 40/06

(52) U.S. Cl. CPC G06Q 40/06

(57) ABSTRACT

Enhanced tools and techniques are provided for collecting, processing, and analyzing 529 plan data. In one embodiment, the process includes a computer-based method for identifying related 529 plan accounts from a plurality of 529 plan accounts, including identifying 529 plan accounts having a common beneficiary or identifying 529 plan accounts having a common owner/beneficiary combination; and, aggregating the information for related 529 plan accounts in a computer implemented aggregation database.

### CROSS-REFERENCE TO RELATED APPLICATIONS

This application is a continuation application claiming priority under 35 U.S.C. §120 to U.S. patent application Ser. No. 14/657,809, filed Mar. 13, 2015, which is a continuation-in-part application claiming priority under 35 U.S.C. §120 to U.S. patent application Ser. No. 14/076,394, filed Nov. 11, 2013, which is a continuation application claiming priority under 35 U.S.C. §120 to U.S. patent application Ser. No. 13/348,116, filed Jan. 11, 2012, now U.S. Pat. No. 8,583,532, which is a continuation application claiming priority under 35 U.S.C. §120 to U.S. patent application Ser. No. 13/012,488, filed Jan. 24, 2011, which is a continuation application claiming priority under 35 U.S.C. §120 to U.S. patent application Ser. No. 12/797,358, filed Jun. 9, 2010, now U.S. Pat. No. 7,877,310, which is a continuation application claiming priority under 35 U.S.C. §120 to U.S. patent application Ser. No. 11/710,685, filed Feb. 26, 2007, now U.S. Pat. No. 7,756,771, which is a continuation application claiming priority under 35 U.S.C. §120 to U.S. patent application Ser. No. 11/477,170, filed Jun. 28, 2006, which is a continuation application claiming priority under 35 U.S.C. §120 to U.S. patent application Ser. No. 11/255,476, filed Oct. 21, 2005, which claims the benefit under 35 U.S.C. §119(e) of U.S. Provisional Patent Application Ser. No. 60/621,021, filed Oct. 21, 2004, the entire disclosures of which are hereby incorporated by reference herein.

### FIELD OF THE INVENTION

This application discloses an invention that is related, generally and in various embodiments, to systems and methods for determining various aspects of different 529 plans by collecting and analyzing aggregated data derived from multiple plan providers.

### BACKGROUND

With the increased recognition of the importance of higher education, more and more people are determined to attend college after graduating from high school. Unfortunately, the cost of attending college continues to rise. To help make attending college more affordable, many states have enacted legislation to establish financial products commonly known as 529 plans. Money invested in a 529 plan accumulates on a tax-deferred basis, thereby making it an attractive investment vehicle for meeting future college education expenses. Generally, for a given state, the state awards a mandate to a program manager to administer the 529 plan authorized by the state. The program manager may subsequently authorize other providers (e.g., mutual fund companies) to run their own 529 plans under the program manger's mandate. Each account in a 529 plan of a given state has an owner and a beneficiary associated therewith. The beneficiary can be the beneficiary of multiple accounts, and each account may have a different owner.

Generally, each state sets a maximum limit associated with a 529 plan account beneficiary, and the administrator of each 529 plan is responsible for complying with the state's maximum limit. For some 529 plans, the maximum limit concerns a total fair market value for 529 plan accounts having the same beneficiary. For other 529 plans, the maximum limit concerns a total value of contributions made to 529 plan accounts having the same beneficiary.

Internal Revenue Service regulations require 529 plans determine an earnings portion of each distribution made therefrom as of the date of the distribution. When the distribution is for a 529 plan account that has the same owner/beneficiary combination as one or more additional 529 plan accounts, each of the 529 plan accounts having the same owner/beneficiary combination need to be aggregated in order to determine the correct earnings portion of the distribution. There may be any number of accounts that need to be aggregated.

From the foregoing, it is apparent that the regulatory burden imposed on administrators of 529 plans can be significant. Unfortunately, many administrators are not currently able to meet the various requirements in a uniform, cost-effective manner.

### BRIEF DESCRIPTION OF THE DRAWINGS

FIG. 1 illustrates various embodiments of a method for determining an earnings portion of a distribution from a 529 plan;

FIG. 2 illustrates various embodiments of a system for determining an earnings portion of a distribution from a 529 plan; and,

FIG. 3 schematically illustrates a computer architecture diagram including an example of a process flow involving an aggregation database programmed for use in connection with various embodiments of the invention.

### DETAILED DESCRIPTION

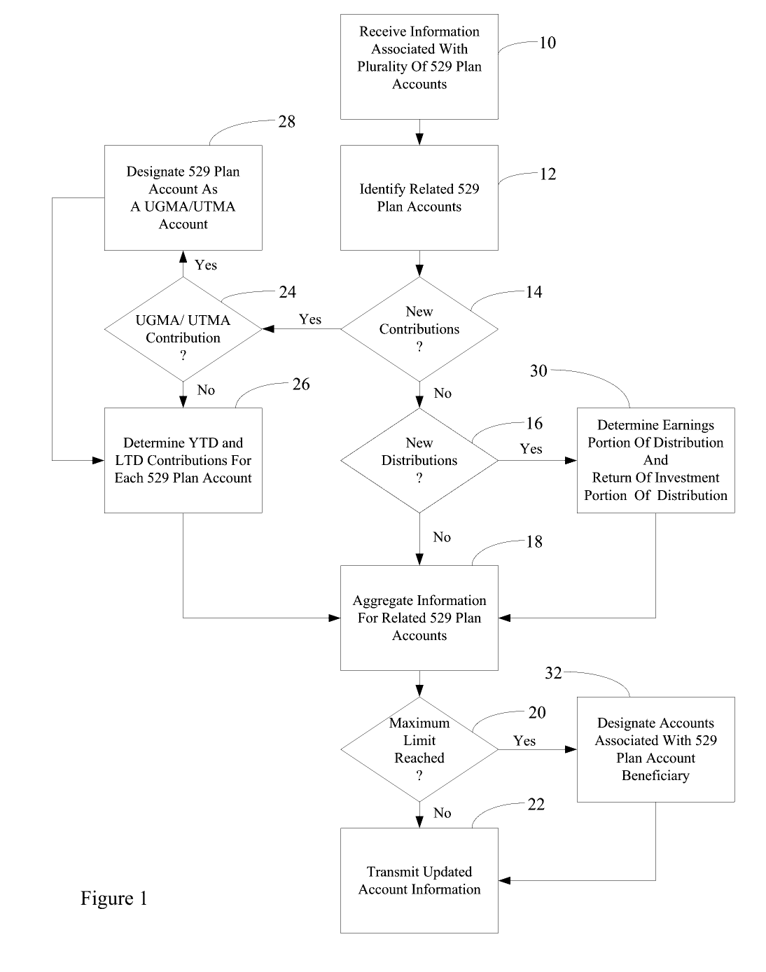

FIG. 1 illustrates various embodiments of a method for determining an earnings portion from a distribution from a 529 plan. Prior to the implementation of the method illustrated in FIG. 1, starting positions may be provided by various 529 plan providers for each 529 plan account. The starting positions may be defined by the fair market value (FMV) of the account, the life-to-date contributions (LTD Cont) to the account, and the life-to-date return of investment (LTD ROI). For ease of description purposes only, the method will be described in terms of a 529 plan for a given state. However, one skilled in the art will readily recognize that the method can be implemented for any number of 529 plans for any number of states, either sequentially or concurrently.

The process illustrated in FIG. 1 begins at block 10, where a service provider (e.g., PFPC) receives information associated with a plurality of 529 plan accounts. The information may be received directly or indirectly from a 529 plan provider, and one skilled in the art will appreciate that the service provider may receive such information from any number of 529 plan providers for any number of states. The information may be received at a computing device associated with the service provider and stored in a database that is in communication with the computing device. The information may include price, position and activity information for each 529 plan account in the 529 plan. The information may also include a state plan ID, an owner ID and a beneficiary ID for each 529 plan account. According to various embodiments, the owner ID may be the owner's social security number and the beneficiary ID may be the beneficiary's social security number. The process described at block 10 may occur on a periodic basis such as, for example, on a daily basis.

From block 10, the process advances to block 12, where related 529 plan accounts are identified. Identifying the related 529 plan accounts includes identifying 529 plan accounts having a common beneficiary and identifying 529 plan accounts having a common owner/beneficiary combination. The process described at block 12 may be repeated for any number of 529 plans for any number of states, either sequentially or concurrently. According to various embodiments, such 529 plan accounts may be designated in a manner that facilitates the grouping together of the accounts for aggregation purposes. The identification process described at block 12 may occur on a periodic basis such as, for example, on a daily basis.

From block 12, the process advances to block 14, where it is determined whether any new contributions have been made to any of the 529 plan accounts that collectively comprise the 529 plan. The determination is made based on a comparison of the information received at block 10 and information stored at the database described hereinbefore. The process described at block 14 may be repeated for any number of 529 plans for any number of states, either sequentially or concurrently.

From block 14, the process advances to block 16 or to block 24. If it is determined that a new contribution has not been made to any of the 529 plan accounts, the process advances from block 14 to block 16, where it is determined whether a new distribution has occurred from any of the 529 plan accounts. The determination is made based on a comparison of the information received at block 10 and information stored at the database described hereinbefore. The process described at block 16 may be repeated for any number of 529 plans for any number of states, either sequentially or concurrently.

From block 16, the process advances to block 18 or block 30. If it is determined that a new distribution from any of the 529 plan accounts has not occurred, the process advances from block 16 to block 18, where the information received at block 10 is aggregated for the related 529 plan accounts. The information may be aggregated for 529 plan accounts having a common beneficiary and for 529 plan accounts having a common owner/beneficiary combination. The process described at block 18 may be repeated for any number of 529 plans for any number of states, either sequentially or concurrently.

From block 18, the process advances to block 20, where it is determined, for each 529 plan account beneficiary, whether a maximum limit associated with the respective 529 plan account beneficiary has been reached. The maximum limit is generally set forth in the 529 plan of the given state, and different states may set different maximum limits. According to various embodiments, the maximum limit may be a maximum aggregate market value for all 529 plan accounts having a common beneficiary. According to other embodiments, the maximum limit may be a maximum aggregate total for life-to-date contributions for all 529 plans having a common beneficiary. The process described at block 20 may be repeated for any number of 529 plans for any number of states, either sequentially or concurrently. If a beneficiary associated with a particular 529 plan account is not associated with any other 529 plan accounts in the various 529 plans of the given state, the aggregated market value of the particular 529 plan account is the same as the market value of the particular 529 plan account. Similarly, the aggregate total for life-to-date contributions for the particular 529 plan account is the same as the life-to-date contributions for the particular 529 plan account.

From block 20, the process advances to block 22 or to block 32. For each 529 plan account beneficiary, if the aggregated market value of the 529 account or accounts associated with the given beneficiary does not exceed the maximum allowable aggregated market value, the process advances to block 22, where the updated 529 plan account information is transmitted to the appropriate plan provider. The process described at block 20 may be repeated for any number of 529 plans in any number of states, either sequentially or concurrently.

Returning to block 14, if it is determined that a new contribution has been made to any of the 529 plan accounts, the process advances from block 14 to block 24, where it is determined whether the new contribution is a UGMA/UTMA contribution. The process described at block 24 may be repeated for any number of 529 plans for any number of states, either sequentially or concurrently.

From block 24, the process advances to block 26 or to block 28. If it is determined that the new contribution is not a UGMA/UTMA contribution, the process advances from block 24 to block 26, where the year-to-date contributions and the life-to-date contributions are determined for each 529 plan account. The updated values of the year-to-date contributions and the life-to-date contributions may be stored in the database described hereinbefore. The process described at block 26 may be repeated for any number of new contributions, either sequentially or concurrently.

From block 26, the process advances to block 18, where the updated values of the year-to-life contributions and the life-to-date contributions, and the information received at block 10, is aggregated for the related 529 plan accounts. From block 18, the process advances to block 20, where the process advances as described hereinbefore.

Returning to block 24, if it is determined that the new contribution is a UGMA/UTMA contribution, the process advances from block 24 to block 28, where the 529 plan account is designated as a UGMA/UTMA account. According to various embodiments, such accounts are designated in a manner that facilitates the separation of UGMA and UTMA accounts from non-UGMA/UTMA accounts. The designation of the UGMA/UTMA accounts allows for the UGMA/UTMA accounts to be aggregated separately from the non-UGMA/UTMA accounts. The process described at block 28 may be repeated for any number of new contributions, either sequentially or concurrently.

From block 28, the process advances to block 26, where the process advances as described hereinbefore, except that UGMA/UTMA accounts are subsequently aggregated separately from non-UGMA/UTMA accounts.

Returning to block 16, if it is determined that a new distribution from any of the 529 plan accounts has occurred, the process advances from block 16 to block 30, where an earnings portion of the distribution is determined and a return of investment portion of the distribution is determined. As each 529 plan account has an owner/beneficiary combination associated therewith, the distribution has an owner/beneficiary combination associated therewith. According to various embodiments, the earnings portion is determined by multiplying the distribution amount by an earnings ratio, where the earnings ratio is equal to the earnings divided by the aggregate market value of the 529 plan accounts having the owner/beneficiary combination that is associated with the distribution. According to various embodiments, the earnings portion may be determined by the following equation:

$$E P = \frac{M V - ( C - R O I ) \times D}{M V}$$

where EP equals the earnings portion, MV equals an aggregate market value, C equals an aggregate value of contributions, ROI equals an aggregate value of return of investment, and D equals the distribution amount. According to various embodiments, the return of investment portion is determined by subtracting the earnings portion from the distribution amount. The process described at block 30 may be repeated for any number of distributions, either sequentially or concurrently. The service provider may use the information determined at block 30 to provide consolidated tax reporting (e.g., one tax form and one 1099Q for related distributions). From block 30, the process advances to block 18, where the process advances as described hereinbefore.

Returning to block 20, if it is determined that a maximum limit associated with a 529 plan account beneficiary has been reached, the process advances to block 32, where each of the 529 plan accounts associated with the 529 plan account beneficiary are appropriately designated. According to various embodiments, attempts to subsequently contribute to any of the designated 529 plan accounts may be automatically rejected by the various service providers. The process described in block 32 may be repeated for any number of beneficiaries, either sequentially or concurrently. From block 32, the process advances to block 22, where the process advances as described hereinbefore.

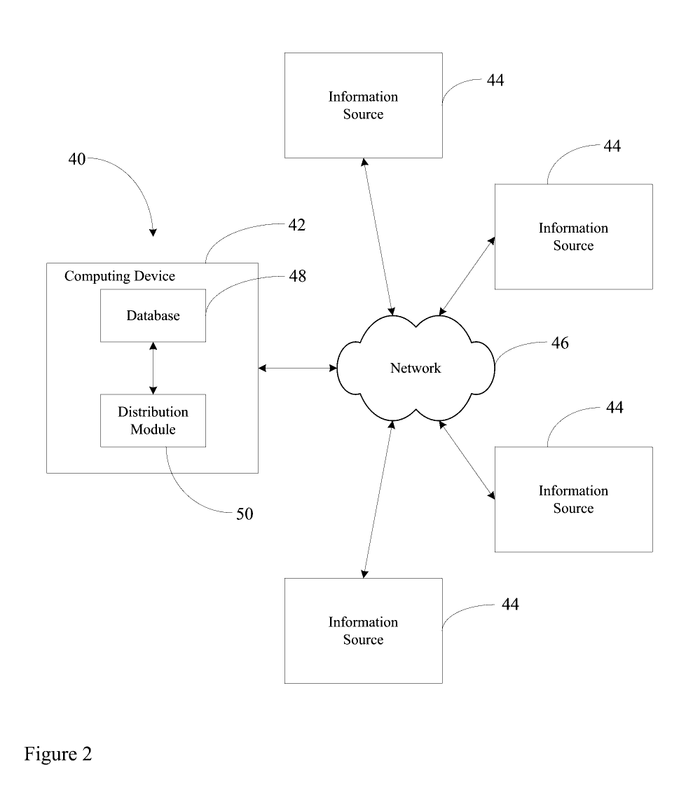

FIG. 2 illustrates a system 40 for determining an earnings portion of a distribution from a 529 plan. The system 40 may be utilized to implement the method described hereinbefore. The system 40 includes a computing device 42 in communication with one or more information sources 44 via a network 46 having wired or wireless data pathways. Each information source 44 may be associated with a different 529 plan provider, and is configured to transmit information associated with a plurality of 529 plan accounts to the computing device 42. The network 46 may be, for example, a local area network (LAN), a metropolitan area network (MAN), a wide area network (WAN), the Internet, an Intranet, an Extranet, the Web, a telephony network (e.g., analog, digital, wired, wireless, PSTN, ISDN, or xDSL), a radio network, a television network, a cable network, a satellite network, and/or any other wired or wireless communications network configured to carry data. The network 46 may include one or more elements, such as, for example, intermediate nodes, proxy servers, firewalls, routers, switches, adapters, sockets, and wired or wireless data pathways, configured to direct and/or deliver data.

In general, the system 40 may be structured and arranged to communicate with the information sources 44 via the network 46 using various communication protocols (e.g., HTTP, TCP/IP, UDP, WAP, WiFi, Bluetooth) and/or to operate within or in concert with one or more other communications systems.

The computing device 42 may be associated with a service provider, and may comprise a database 48 and a distribution module 50. The database 48 may be structured and arranged to store information that the computing device 42 receives from the one or more information sources 44. The distribution module 50 is configured for determining an earnings portion of a distribution from at least one 529 plan account and for determining a return of investment portion of the distribution. The distribution module 50 may also be configured for identifying related 529 plan accounts, aggregating information for related 529 plan accounts, and determining when a maximum limit associated with a 529 plan account beneficiary is reached.

The distribution module 50 may be implemented utilizing any suitable computer language (e.g., C, C++, Java, JavaScript, Visual Basic, VBScript, Delphi) and may be embodied permanently or temporarily in any type of machine, component, physical or virtual equipment, storage medium, or propagated signal capable of delivering instructions to a device. The distribution module 50 (e.g., software application, computer program) may be stored on a computer-readable medium (e.g., disk, device, and/or propagated signal) such that when a computer reads the medium, the functions described herein are performed. According to various embodiments, the functionality of the distribution module 50 may be implemented by more than one module. Although the computing device 42 is shown as a single unit in FIG. 2 for purposes of convenience, it should be recognized that the computing device 42 may comprise a number of distributed computing devices, inside and/or outside the administrative domain. For example, the computing device 42 may include a personal computer, a workstation, a laptop computer, a network-enabled personal digital assistant, a network-enabled mobile telephone, etc. Other examples of the computing device 42 include, but are not limited to, a server, a microprocessor, an integrated circuit, fax machine or any other component, machine, tool, equipment, or some combination thereof capable of responding to and executing instructions and/or using data.

The computing device 42 may perform the above-described actions automatically and may perform the actions for any number of 529 plans in any number of states, for any number of 529 plan accounts, and for any number of owners and beneficiaries. In order to perform the actions described hereinabove, the computing device 42 may execute a series of instructions. The instructions may be software code to be executed by the computing device 42. The software code may be stored as a series of instructions or commands on a computer readable medium such as a random access memory (RAM) and/or a read only memory (ROM), a magnetic medium such as a hard-drive or a floppy disk, or an optical medium such as a CD-ROM. The software code may be written in any suitable programming language using any suitable programming technique. For example, the software code may be written in C using procedural programming techniques, or in Java or C++ using object-oriented programming techniques.

In various embodiments, master aggregation services may be provided for multiple offerings associated with the same 529 Plan (e.g., for all Colorado 529 Plan offerings), treating them as a single plan for the purposes of aggregating by owner and/or beneficiary combination and by beneficiary across all owners. These aggregations can provide the basis upon which each individual plan provider may base the following processes: contributions limit tracking may be done for a given beneficiary; earnings may be calculated for a given owner and/or beneficiary combination; investment change tracking and reporting may be facilitated, and distribution activity reporting may be facilitated across all providers.

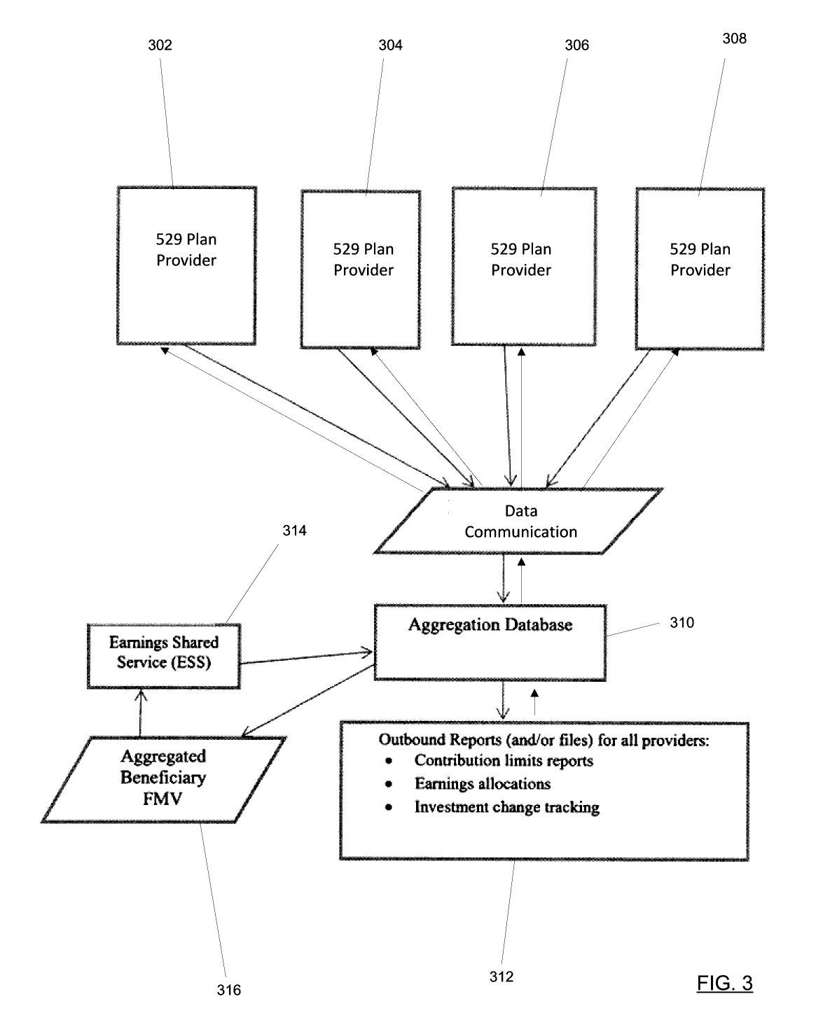

With reference to FIG. 3, data feeds can be communicated from multiple plan providers 302, 304, 306, 308 into an aggregation database 310. As shown, the various providers 302, 304, 306, 308 may communicate data to the aggregration database 310 which can collect information across the various plans associated with the providers 302, 304, 306, 308. The aggregation database 310 can generate one or more reports at block 312 which can be reported back to one or more of the providers 302, 304, 306, 308.

With data provided by the aggregation database 310, calculations can be performed involving various information for a given beneficiary and owner/beneficiary combinations; transmission of data to each entity 302, 304, 306, 308 can be performed as appropriate; and various reports which are reflective of the aggregated data calculations can be generated. The aggregation database 310 may be operatively associated with an earnings shared service 314, such as to make calculations involving aggregated beneficiary FMV data 316, for example. It can be seen that the aggregation database 310 provides the ability to receive file transmissions with 529 Plan related owner/beneficiary level data from multiple plan providers relating to a single state's 529 Plan for the purposes of aggregating the data and analyzing the aggregrated data. The aggregation database 310 may receive non-fund specific 529 Plan beneficiary related data from multiple sources, including the earnings shared service 314.

In certain embodiments, the process can provide the ability to identify the source of each plan provider 302, 304, 306, 308 data transmission to facilitate the specification of that provider 302, 304, 306, 308 on withdrawal, investment tracking and distribution activity reporting. The process may also promote communicating return files generated by the aggregation database to the correct originating plan provider 302, 304, 306, 308. The process may also be used to generate aggregation files, using the appropriate layout, to each of the plan providers 302, 304, 306, 308 having a beneficiary identified on the incoming records of more than one of the providers 302, 304, 306, 308. In other words, a given beneficiary can be identified based on the data feeds of more than one of the plans and designated as requiring aggregation. These response files may be sent only to the plan providers 302, 304, 306, 308 having a position for the beneficiary with the aggregated information. If a given beneficial owner is only identified by a single plan provider 302, 304, 306, 308 there might be no response file generated to the providers 302, 304, 306, 308 upon receipt of that record by the aggregating entity. If there is no multi-plan aggregation required, then there may be no record sent from the aggregation database 310.

In various embodiments, the process provides the ability to generate beneficiary contribution limit reporting based on the informational content of the aggregation database 310. Investment change tracking related reporting can be generated based on the information passed from each individual plan provider 302, 304, 306, 308. For example, an exchange date field stored within the computer systems of the earnings shared service 314 may be defined as a last investment strategy change date. This data field can facilitate tracking by the aggregation database 310 of the most recent investment strategy change activity date applicable to accounts residing on the earnings share service 314. The process may also be used to generate distribution activity reporting (e.g., withdrawal reports) based on the informational content of the aggregation database 310. In other embodiments, the process may provide ad hoc reporting using the aggregation database 310 as a source of data.

In one example, account balance contribution limit tracking and reporting can be performed in connection with the aggregated data in the aggregation database 310. For example, federal rule or regulations may require a 529 Plan to have a “safe harbor” account balance limit for the plan. Such a limit may apply to all accounts established for the benefit of a single beneficiary, regardless of account owner, at which the plan will no longer allow contributions. Such a limit may be $350,000, for example, or another suitable amount. A plan reporting accounts alone or in aggregate on a daily account balance contribution limit report may require corrective measures by the affected manager for future contributions to the account. If the plan is held under one manager, it might be the responsibility of that manager to prevent further contributions. If the plan is held by multiple managers, then each manager may be required to take appropriate action to prevent further contributions. In certain embodiments, any plan receiving contributions that put the aggregated account or accounts in excess of the account balance contribution limit may be required to refund the excess to the client. All such refunds may be based on contributions only, and may not benefit from market gains nor realize loss by market losses while remedial action is being taken. In the event that there are contributions to more than one account with more than one manager on the same day, then the managers may collaboratively communicate to determine operationally the best way to reach the client to seek direction on which account or accounts from which the client would prefer excess amounts to be refunded. In the event that the client cannot be reached in a reasonable time (e.g., five business days), then a pro-rata share of the excess may be refunded from each affected account. Affected accounts, upon fair market value determination of the accounts moving below the account balance contribution limit, may be allowed to make contributions to the account or accounts until such time when the account again reaches the account balance contribution limit, either by subsequent contributions or market action.

In another example of applying data stored within the aggregation database 310, the process may be employed for tracking and reporting aggregation of distributions. Federal rules and regulations may require a 529 Plan to aggregate all accounts with the same account owner/beneficiary relationship for the purposes of calculating cost basis and gain of a distribution. When a client takes a distribution and has only one account for a beneficiary, the earnings ratio of that single account may be applied to the distribution. However, in the event that a client owns an account in multiple plans for the same beneficiary at the time of a distribution, the cost basis and earnings/loss of each plan may need to be aggregated as though they are derived from a single account. Aggregated earnings (i.e., gain or loss) among all plans can be calculated as: (sum of market value of all accounts)−(sum of principal of all accounts), wherein the (sum of principal of all accounts)=net contributions−return of investment (ROI). If distribution activity is detected where there are accounts with the same account owner and beneficiary relationship with multiple plans, then a report can be generated to provide the affected manager or managers with the distribution activity, market value and net contribution (basis) amounts. The total of all of the plan cost basis and earnings creates an aggregated earnings ratio that can be applied to a distribution. Earnings ratio can be calculated by taking the aggregated earnings divided by the aggregated FMV. For example, assume an account has $3000 in LTD contributions and a FMV of $3400. The earnings of $400 is divided by the FMV of $3400 giving an Earnings Ratio of 0.1176. So if a shareholder on that account takes a distribution of $500, then the earnings on that distribution would be 0.1176*$500=58.82, and the ROI is 500−58.82=441.18.

Plans reported with distribution activity to be aggregated may be required to have immediate attention from the affected manager or managers. The affected manager can use the reported net contribution and market value amounts in each plan to restate the earnings of the distribution to the account owner, new trustee, and/or the IRS, for example. While generally only the distributing manager makes adjustments, certain distributions may require basis adjustments on the surviving positions held by other managers. In the event of an aggregated loss on the accounts, distributions may be treated as a reduction of basis only and reported to the client as a distribution from principal (basis) only. If, as a result of this treatment, there is remaining basis in the distributing account that exceeds the balance of that account, such excess can be applied to other open account or accounts on a prorata basis. In the event of an aggregated gain on the accounts, the distribution can be reported as basis/gain at a ratio of: (market value of all accounts minus principal of all accounts) divided by (market value of all accounts) times the distribution amount. In the event of a distribution from an account with a current loss, but aggregated as a gain, any basis that is in excess of the balance of the account can be applied to other open accounts. In the event of cost basis adjustments where the account owner maintains open positions in more than one plan, a basis adjustment can be applied to the remaining open positions based on percentage of net basis in those open positions before the adjustment is applied.

In another example, data from the aggregation database 310 may be used in connection with investment election change tracking and reporting. Federal rules or regulations may require a 529 Plan to limit the number of changes in investment options within the plan to once per calendar year, for example. Changes within and among plans offered within the same state on accounts having the same owner and the same beneficiary may need to be treated as an investment election change and may need to be subjected to the calendar year limit. A client may make multiple changes in multiple plans, as long as they occur on the same day. The investment election change may include exchanges within one plan or movement of current assets between different plans. Any plans reporting investment election change activity may require attention where multiple plans hold accounts for the same account owner/beneficiary relationship. Managers may need to operationally prohibit the account owner from making additional investment election changes until the next calendar year. In the event of subsequent account openings by an account owner for the benefit of the same beneficiary, such additional accounts might be prohibited from making investment election changes until the next calendar year.

While several embodiments of the disclosed invention have been described, it should be apparent, however, that various modifications, alterations and adaptations to those embodiments may occur to persons skilled in the art with the attainment of some or all of the advantages of the disclosed invention. For example, some of the method steps described hereinabove with respect to FIG. 1 may be performed concurrently or in a different order. It is therefore intended to cover all such modifications, alterations and adaptations without departing from the scope and spirit of the disclosed invention as defined by the appended claims.

1-19. (canceled)

20. A method for qualified tuition plan providers to comply with state and federal requirements associated with qualified tuition plan accounts, the method comprising:
receiving on a periodic basis, by a service provider device, information associated with a plurality of qualified tuition plan (QTP) accounts, wherein the information is received via a network from a plurality of information source devices, wherein each information source device is associated with a QTP provider providing at least one QTP account of the plurality of QTP accounts;
storing, in a database, the received information;
identifying on a periodic basis, by the service provider device, groups of related QTP accounts, wherein each group of related QTP accounts comprises QTP accounts of the plurality of QTP accounts associated with a same beneficiary;
aggregating, by the service provider device, for each group of related QTP accounts, the received information associated with the QTP accounts of each respective group of related QTP accounts;
determining, by the service provider device, for each group of related QTP accounts comprising a distributing QTP account, an earnings portion (EP) of a distribution from the distributing QTP account as:
$$E P = ( \frac{M V - ( C - R O I )}{M V} ) \times D ,$$
wherein MV is an aggregate market value for the respective group of related QTP accounts comprising the distributing QTP account, C is an aggregate value of contributions to the respective group of related QTP accounts comprising the distributing QTP account, ROI is an aggregate value of return of investment for the respective group of related QTP accounts comprising the distributing QTP account, and D is an amount of the distribution from the distributing QTP account;
determining, by the service provider device, for each group of related QTP accounts, whether a current aggregate value of the QTP accounts of each respective group of related QTP accounts has reached a maximum limit associated with its respective beneficiary, wherein the maximum limit comprises a state-mandated maximum aggregate value;
upon determining that the maximum limit for a respective group of related QTP accounts has been reached:
designating, by the service provider device, the QTP accounts of the respective group of related QTP accounts as being associated with the maximum limit; and
transmitting via the network, by the service provider device, the designation to each QTP provider providing each designated QTP account so that each QTP provider can automatically reject subsequent contributions to its respective designated QTP account;
upon determining that the maximum limit for a respective group of related QTP accounts has not been reached:
transmitting via the network, by the service provider device, the current aggregate value to each QTP provider providing the QTP accounts of the respective group of related QTP accounts so that each QTP provider can comply with the state-mandated maximum aggregate value; and
transmitting via the network, by the service provider device, each determined earning portion to each respective QTP provider providing each respective distributing QTP account so that each respective QTP provider can comply with federal requirements associated with its distribution from its respective distributing QTP account.

21. The method of claim 20, wherein the received information includes price, position, and activity information associated with each of the plurality of QTP accounts.

22. The method of claim 20, wherein the received information includes starting positions associated with each of the plurality of QTP accounts, wherein each starting position includes a fair market value, a life-to-date contributions value, and a life-to-date return of investment value.

23. The method of claim 20, further comprising aggregating the received information for UGMA/UTMA accounts separately from the received information for non-UGMA/UTMA accounts.

24. The method of claim 20, further comprising determining, by the service provider device, for each respective group of related QTP accounts comprising the distributing QTP account, a return of investment portion of the distribution from each respective distributing QTP account by subtracting the determined earning portion for each respective distributing QTP account from each respective distribution amount.

25. The method of claim 20, further comprising updating the database with a value for year-to-date contributions and a value for life-to-date contributions for each of the plurality of QTP accounts.

26. The method of claim 20, wherein the current aggregate value comprises a current aggregate market value and the state-mandated maximum aggregate value comprises a maximum aggregate market value.

27. The method of claim 20, wherein the current aggregate value comprises a current aggregate life-to-date contributions total value and the state-mandated maximum aggregate value comprises a maximum aggregate life-to-date contributions total value.

28. The method of claim 20, wherein the received information comprises a life-to-date contributions value and a year-to-date contributions value associated with each of the plurality of QTP accounts, the method further comprising:
determining, by the service provider device, whether a contribution has been made to any of the plurality of QTP accounts by:
comparing, for each QTP account, each received life-to-date contributions value to a life-to-date contributions value previously stored in the database for the respective QTP account; and
comparing, for each QTP account, each received year-to-date contributions value to a year-to-date contributions value previously stored in the database for the respective QTP account; and
determining, by the service provider device, an updated year-to-date contributions value and an updated life-to-date contributions value for each QTP account determined as having a contribution; and
storing the updated year-to-date contributions value and the updated life-to-date contributions value in the database.

29. A system for qualified tuition plan providers to comply with state and federal requirements associated with qualified tuition plan accounts, the system comprising:
a plurality of qualified tuition plan (QTP) provider information source devices;
a network; and
a service provider device in communication with the plurality of QTP provider information source devices via the network, wherein the service provider device comprises a database and a distribution module, and wherein the distribution module is programmed to:
receive, on a periodic basis, information associated with a plurality of QTP accounts, wherein the information is received via the network from the plurality of QTP provider information source devices, and wherein each QTP provider provides at least one QTP account of the plurality of QTP accounts;
store the received information in the database;
identify, on a periodic basis, groups of related QTP accounts, wherein each group of related QTP accounts comprises QTP accounts of the plurality of QTP accounts associated with a same beneficiary;
aggregate, for each group of related QTP accounts, the received information associated with the QTP accounts of each respective group of related QTP accounts;
determine, for each group of related QTP accounts comprising a distributing QTP account, an earnings portion (EP) of a distribution from the distributing QTP account as:
$$E P = ( \frac{M V - ( C - R O I )}{M V} ) \times D ,$$
wherein MV is an aggregate market value for the respective group of related QTP accounts comprising the distributing QTP account, C is an aggregate value of contributions to the respective group of related QTP accounts comprising the distributing QTP account, ROI is an aggregate value of return of investment for the respective group of related QTP accounts comprising the distributing QTP account, and D is an amount of the distribution from the distributing QTP account;
determine, for each group of related QTP accounts, whether a current aggregate value of the QTP accounts of each respective group of related QTP accounts has reached a maximum limit associated with its respective beneficiary, wherein the maximum limit comprises a state-mandated maximum aggregate value;
upon determining that the maximum limit for a respective group of related QTP accounts has been reached:
designate the QTP accounts of the respective group of related QTP accounts as being associated with the maximum limit; and
transmit, via the network, the designation to each QTP provider providing each designated QTP account so that each QTP provider can automatically reject subsequent contributions to its respective designated QTP account;
upon determining that the maximum limit for a respective group of related QTP accounts has not been reached:
transmit, via the network, the current aggregate value to each QTP provider providing the QTP accounts of the respective group of related QTP accounts so that each QTP provider can comply with the state-mandated maximum aggregate value; and
transmit, via the network, each determined earning portion to each respective QTP provider providing each respective distributing QTP account so that each respective QTP provider can comply with federal requirements associated with its distribution from its respective distributing QTP account.

30. The system of claim 29, wherein the distribution module is further programmed to receive a social security number of at least one beneficiary.

31. The system of claim 29, wherein the distribution module is further programmed to receive a starting position associated with each of the plurality of QTP accounts.

32. The system of claim 29, wherein the distribution module is further programmed to receive a fair market value, a life-to-date contributions value, and a life-to-date return of investment value associated with each of the plurality of QTP accounts.

33. The system of claim 29, wherein the distribution module is further programmed to aggregate the received information for UGMA/UTMA accounts separately from the received information for non-UGMA/UTMA accounts.

34. The system of claim 29, wherein the distribution module is further programmed to determine, for each respective group of related QTP accounts comprising the distributing QTP account, a return of investment portion of the distribution from each respective distributing QTP account by subtracting the determined earning portion for each respective distributing QTP account from each respective distribution amount.

35. The system of claim 29, wherein the distribution module is further programmed to update the database with a value for year-to-date contributions and a value for life-to-date contributions for each of the plurality of QTP accounts.

36. The system of claim 29, wherein the current aggregate value comprises a current aggregate market value and the state-mandated maximum aggregate value comprises a maximum aggregate market value.

37. The system of claim 29, wherein the current aggregate value comprises a current aggregate life-to-date contributions total value and the state-mandated maximum aggregate value comprises a maximum aggregate life-to-date contributions total value.

38. A non-transitory computer-readable medium for qualified tuition plan providers to comply with state and federal requirements associated with qualified tuition plan accounts, wherein said non-transitory computer-readable medium comprises instructions stored thereon, which when executed by a processor of a service provider device, cause the processor to:
receive, on a periodic basis, information associated with a plurality of qualified tuition plan (QTP) accounts, wherein the information is received via a network from a plurality of information source devices, wherein each information source device is associated with a QTP provider providing at least one QTP account of the plurality of QTP accounts;
store the received information in a database;
identify, on a periodic basis, groups of related QTP accounts, wherein each group of related QTP accounts comprises QTP accounts of the plurality of QTP accounts associated with a same beneficiary;
aggregate, for each group of related QTP accounts, the received information associated with the QTP accounts of each respective group of related QTP accounts;
determine, for each group of related QTP accounts comprising a distributing QTP account, an earnings portion (EP) of a distribution from the distributing QTP account as:
$$E P = ( \frac{M V - ( C - R O I )}{M V} ) \times D ,$$
wherein MV is an aggregate market value for the respective group of related QTP accounts comprising the distributing QTP account, C is an aggregate value of contributions to the respective group of related QTP accounts comprising the distributing QTP account, ROI is an aggregate value of return of investment for the respective group of related QTP accounts comprising the distributing QTP account, and D is an amount of the distribution from the distributing QTP account;
determine, for each group of related QTP accounts, whether a current aggregate value of the QTP accounts of each respective group of related QTP accounts has reached a maximum limit associated with its respective beneficiary, wherein the maximum limit comprises a state-mandated maximum aggregate value;
upon determining that the maximum limit for a respective group of related QTP accounts has been reached:
designate the QTP accounts of the respective group of related QTP accounts as being associated with the maximum limit; and
transmit, via the network, the designation to each QTP provider providing each designated QTP account so that each QTP provider can automatically reject subsequent contributions to its respective designated QTP account;
upon determining that the maximum limit for a respective group of related QTP accounts has not been reached:
transmit, via the network, the current aggregate value to each QTP provider providing the QTP accounts of the respective group of related QTP accounts so that each QTP provider can comply with the state-mandated maximum aggregate value; and
transmit, via the network, each determined earning portion to each respective QTP provider providing each respective distributing QTP account so that each respective QTP provider can comply with federal requirements associated with its distribution from its respective distributing QTP account.

39. The non-transitory computer-readable medium of claim 38, further comprising instructions stored thereon, which when executed by the processor, cause the processor to:
determine, for each respective group of related QTP accounts comprising the distributing QTP account, a return of investment portion of the distribution from each respective distributing QTP account by subtracting the determined earning portion for each respective distributing QTP account from each respective distribution amount.
